(19) United States
(12) Patent Application Publication
(10) Pub. No.: US 2018/0281364 A1
(43) Pub. Date: Oct. 4, 2018

(54) SYNTHETIC RESIN LEATHER AND METHOD FOR PRODUCING SAME

(71) Applicants: HONDA MOTOR CO., LTD., Tokyo (JP); OKAMOTO INDUSTRIES, INC., Tokyo (JP)

(72) Inventors: Tomoyuki UEMURA, Chuo Wako-shi (JP); Yoshinari HATORI, Shizuoka (JP); Ichiro FUJITA, Shizuoka (JP); Takaji SUZUKI, Shizuoka (JP)

(21) Appl. No.: 15/765,376

(22) PCT Filed: Oct. 7, 2016
(86) PCT No.: PCT/JP2016/079974

§ 371 Date: Apr. 2, 2018

(30) Foreign Application Priority Data
Oct. 8, 2015 (JP) 2015-200485

(51) Int. Cl. B32B 27/30; B29C 43/24; B29C 43/00; B29C 43/32; B32B 7/12; B32B 37/12

(52) U.S. Cl. CPC B32B 27/304; B29C 43/24; B29C 43/003; B29K 2027/06; B32B 7/12; B32B 37/12; B29C 43/32

(57) ABSTRACT

Provided is a synthetic resin leather having high flexibility and favorable strength, wear resistance with respect to repeated rubbing, and chemical resistance with respect to contact with a human body. A surface treatment agent including a mixture of a polycarbonate urethane and an ester urethane crosslinked with a carbodiimide is applied to a surface side of a film 1 constituted primarily of vinyl chloride resin, in order to form a surface treatment layer 1a having excellent flexibility, wear resistance and oleic acid resistance.

### TECHNICAL FIELD

The present invention relates to a synthetic resin leather having a film constituted primarily of a vinyl chloride resin such as PVC, and to a producing method therefor.

### BACKGROUND ART

Conventional examples of this kind of synthetic resin leather include synthetic resin leathers used in sheet materials for seating, in which a synthetic resin layer made of vinyl chloride resin or the like is joined to a base cloth via an adhesive, a skin layer is formed on the surface of the synthetic resin layer to protect the surface and preserve the strength of the synthetic resin layer and impart tactile properties, and then the skin layer is laminated to the synthetic resin layer while applying a grain pattern or printed pattern to the surface of the skin layer as appropriate, or else such a grain pattern or printed pattern is applied after lamination (see for example PTL 1).

### CITATION LIST

### Patent Literature

[PTL 1] Japanese Patent Application Publication No. H09-228258

### SUMMARY OF INVENTION

### Technical Problem

Synthetic resin leathers having films constituted primarily of vinyl chloride resin as in the prior art were developed to have flexibility represented by good bendability and suppleness, and thus clearly have a separate history of development from synthetic leathers having strong films.

Although the prior art described in the PTL 1 above has improved functions of strength including surface scratch resistance and tear strength in addition to flexibility represented by bendability and suppleness, it still does not provide sufficient wear resistance and chemical resistance with respect to contact with other objects such as the user's skin and clothes, which rub repeatedly against the surface of the skin layer.

Specifically, when a synthetic resin leather is applied to the entrance and exit side of a vehicle seat, it is required to have adequate wear resistance in addition to flexibility represented by bendability and suppleness. In particular, because relief patterns such as the aforementioned grain pattern and printed pattern are formed on the surface of the skin layer, the convex parts of these relief patterns are liable to peeling and the like due to repeated rubbing, and a good balance of durability has not been achieved for seating applications.

Moreover, since human sebum and perspiration, hydrating lotions and the like often adhere to vehicle seats, chairs, sofas and the like, the properties of synthetic resins leathers used in situations involving frequent direct or indirect contact with the human body must include chemical resistance to higher fatty acids such as oleic acid, which are often contained in sebum, sweat, hydrating lotions and the like.

### Solution to Problem

To solve such problems, the synthetic resin leather and method for producing same of the present invention include at least the configurations of the following independent claims.

[Claim 1] A synthetic resin leather comprising a surface treatment layer formed on a surface side of a film constituted primarily of a vinyl chloride resin, wherein

the surface treatment layer is formed by applying a surface treatment agent including a mixture of a polycarbonate urethane and an ester urethane crosslinked with a carbodiimide group-containing crosslinking agent.

[Claim 5] A method for producing a synthetic resin leather,

the method comprising:

a film molding step in which a film constituted primarily of a vinyl chloride resin is molded;

a surface treatment step in which a surface treatment agent including a mixture of a polycarbonate urethane and an ester urethane crosslinked either with a carbodiimide group-containing aqueous crosslinking agent or with this carbodiimide group-containing aqueous crosslinking agent and an isocyanate based crosslinking agent is applied to a surface of the molded film, in order to form a surface treatment layer; and

a base material adhering step in which a base material is made to adhere to a rear surface side of the film.

### BRIEF DESCRIPTION OF DRAWINGS

FIG. 1 is an explanatory drawing (partial enlarged cross-section) showing the overall configuration of a synthetic resin leather according to an embodiment of the present invention.

FIG. 2 is an explanatory drawing (partial enlarged cross-section) showing a modified example of a synthetic resin leather according to an embodiment of the present invention.

FIG. 3 is an explanatory drawing (partial enlarged cross-section) showing a modified example of a synthetic resin leather according to an embodiment of the present invention.

### DESCRIPTION OF EMBODIMENTS

Embodiments of the present invention are explained in detail based on the drawings.

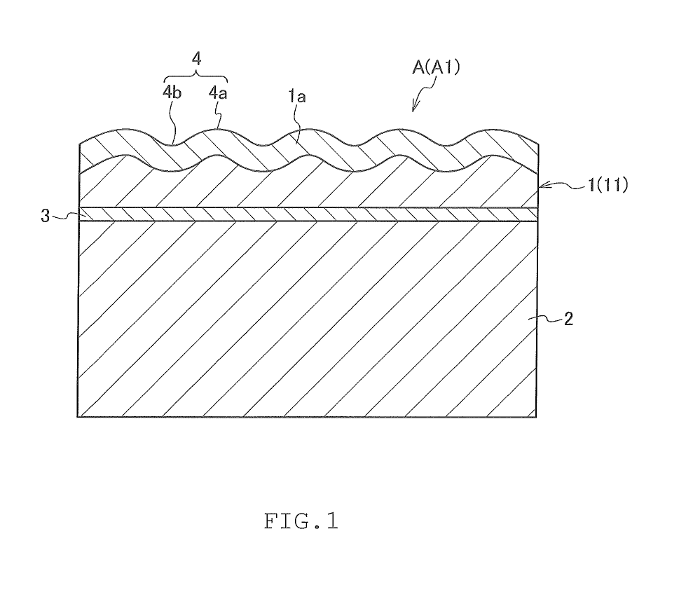

As shown in FIGS. 1 to 3, synthetic resin leather A of an embodiment of the present invention includes a surface treatment layer 1a formed on the surface side of a film 1.

The film 1 is a thin film layer constituted primarily of a vinyl chloride resin such as soft polyvinyl chloride (PVC).

In the case of a mixed resin component, the vinyl chloride resin component is contained in the amount of at least 50% of the layer constituting the film 1, or if there are multiple kinds of resin components, the vinyl chloride resin component is the component constituting the highest share of these components. Fundamentally, as in the prior art described above, this film 1 has good flexibility including bendability and suppleness as well as good strength because it is made of a mixed resin including a vinyl chloride resin and another resin component.

The film 1 may be formed as a non-foam layer 11 lacking bubbles on the inside, but may also be formed so as to have a foam layer 12 containing bubbles on the inside produced by including a foaming agent.

The base material 2 described below is also provided on the rear surface side of the film 1. Either the film 1 and the base material 2 are made to adhere and integrated together indirectly by providing an adhesion layer 3 (described below) between the two, or else they are made to adhere and integrated together in such a way that the film 1 and base material 2 are in direct contact with one another.

A fabric such as a knitted fabric, woven fabric or nonwoven fabric or a similar material is used as the base material 2. A knitted fabric such as for example a jersey knit, smooth knit or other plain knit fabric is preferred for imparting leather-like properties.

A knitted fabric using a yarn that has been made elastic by crimping or the like for example is especially desirable. Because polyester is hard, moreover, a knitted fabric that has been made elastic by crimping can be used by preference when the fabric is made entirely of polyester.

In the case of a woven or nonwoven fabric, it is important to give the fabric of the base material 2 flexibility by using, as the yarn constituting the woven material or the short fibers (staple) constituting the nonwoven material, either a yarn or fiber that has been made elastic by crimping or the like, or a yarn that has been worked to confer elasticity during the process of preparing the yarn from short fibers.

Taking the synthetic resin leather A1 shown in FIG. 1 as a specific example of a synthetic resin leather A1 of an embodiment of the present invention, film 1 is formed of non-foam layer 11, a surface treatment layer 1a is lamination-formed on the surface of the non-foam layer 11, and base material 2 adheres to the rear surface of the non-foam layer 11 via adhesion layer 3.

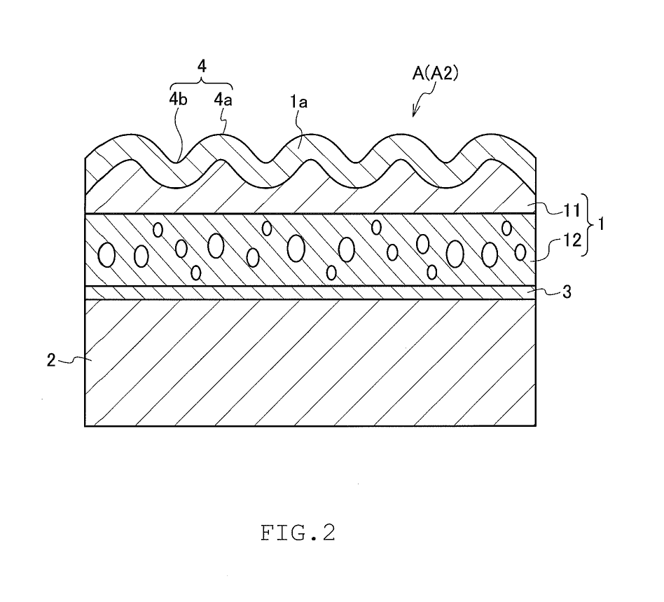

In the case of the synthetic resin leather A2 shown in FIG. 2, the film 1 is formed of the non-foam layer 11 and a foam layer 12 lamination-formed on the rear surface side of the non-foam layer 11, the surface treatment layer 1a is lamination-formed on the surface of the non-foam layer 11, and the base material 2 adheres to the rear surface of the foam layer 12 via the adhesion layer 3.

A hot melt adhesive, acrylic adhesive, two-component polyurethane adhesive, ethylene-vinyl acetate copolymer emulsion, polyvinyl chloride paste or the like is used as the adhesive forming the adhesion layer 3. A two-component polyurethane adhesive that does not inhibit the flexibility of the synthetic resin leather is preferable. The adhesion layer 3 may be applied either to the base material 2 side or to the film 1 side.

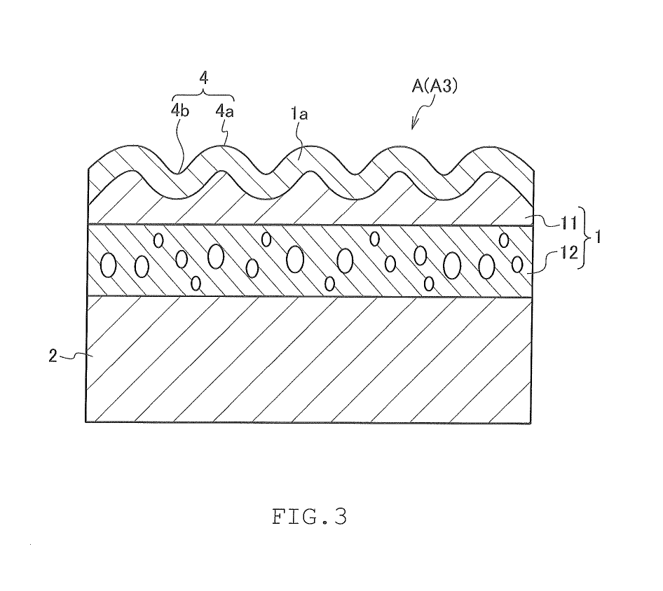

In the case of the synthetic resin leather A3 shown in FIG. 3, the film 1 is formed of the non-foam layer 11 and the foam layer 12 lamination-formed on the rear surface side of the non-foam layer 11, the surface treatment layer 1a is lamination-formed on the surface of the non-foam layer 11, and the film 1 and base material 2 are made to adhere and integrated together directly on the rear surface of the foam layer 12, without the use of an adhesion layer 3.

The material constituting the foam layer 12 that is fixed by direct contact with the base material 2 as in the synthetic resin leather A3 shown in FIG. 3 is a soft polyvinyl chloride, and a foam polyvinyl chloride is especially desirable.

The vinyl chloride resin used in the soft polyvinyl chloride may be vinyl chloride alone, vinyl chloride with another monomer, a copolymer with vinyl acetate, ethylene, propylene, maleic acid ester, methacrylic acid ester, acrylic acid ester, higher vinyl ether or the like, or another vinyl chloride polymer or copolymer or the like commonly used in PVC leather, and any of these alone or a combination of two or more may be used.

A plasticizer, thermal stabilizer, filler or foaming agent or the like as necessary may be added to the soft polyvinyl chloride used to constitute the film 1, and various other additives commonly used in PVC leather may also be compounded, such as pigments, antistatic agents, UV absorbers, light stabilizers, anti-aging agents and the like.

Examples of plasticizers used to soften vinyl chloride resins include common phthalate ester plasticizers such as diisodecyl phthalate (DIDP), di-2-ethylhexyl phthalate (DOP), diisononyl phthalate (DINP), butylbenzyl phthalate (BBP) and diundecyl phthalate (DUP), common fatty acid ester plasticizers such as dioctyl adipate (DOA), dioctyl sebacate (DOS) and dioctyl azelate (DOZ), trimellitate ester plasticizers such as trioctyl trimellitate (TOTM), triaryl phosphate ester plasticizers such as tricresyl phosphate (TCP) and trixylyl phosphate (TXP), epoxy plasticizers such as epoxidized soybean oil, high-molecular-weight plasticizers including polyester plasticizers such as polypropylene adipate, and common plasticizers such as chlorinated paraffin and the like, and one of these or a combination of two or more may be used.

Examples of the thermal stabilizer include metal soaps such as magnesium stearate, aluminum stearate, calcium stearate, barium stearate, zinc stearate, calcium laurate, barium laurate and zinc laurate, sodium, zinc, barium and other metal salts of phenol and naphthol, organic tin compounds such as dibutyltin dilaurate and dibutyltin dimaleate, and phosphite esters such as diethyl phosphite, dibutyl phosphite, dioctyl phosphite, diphenylisodecyl phosphite, tricresyl phosphite, triphenyl phosphite, tris(nonylphenyl)phosphite and triisooctyl phosphite and the like.

An inorganic filler is preferably used as the filler.

Specific examples of inorganic fillers include calcium carbonates such as precipitating calcium carbonate, heavy calcium carbonate and ultrafine calcium carbonate, magnesium carbonate, silicates such as silica, talc, diatomaceous earth, clay and mica, and aluminum hydroxide, alumina and the like.

An organic foaming agent is preferably used as the foaming agent.

Specific examples of organic foaming agents include azodicarbonamide, azobisisobutyronitrile, benzenesulfonylhydrazide, p-toluenesulfonylhydrazide, p, p′-oxybis (benzenesulfonylhydrazide), dinitrosopentanemethylenetetramine, N,N′-dinitroso-N,N′-dimethyl terephthalamide, trihydrazinotriamine and the like. One of these organic foaming agents or a combination of two or more may be used.

The expansion ratio is preferably 1.5× to 7×, or preferably about 2× to 5×. If foaming is excessive stable cells do not form, which is undesirable because the texture of the resulting leather is adversely affected and its strength is reduced.

Moreover, the film 1 is preferably a mixed resin layer including a vinyl chloride resin and a silicone acrylic copolymer represented by chemical formula 1.

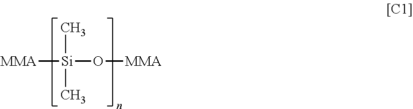

This silicone acrylic copolymer is a copolymer particle (powder) obtained by copolymerizing a polyorganosiloxane having a radical polymerizable group at the end with a (meth)acrylate ester, and the copolymerization ratio of the polyorganosilixane and the (meth)acrylate ester is preferably 60 to 90:10 to 40. Polymerization is by emulsion polymerization or the like. The molecular weight is 100,000 to 500,000, or preferably 150,000 to 400,000.

The particle is 5 to 400 μm in size, and amorphous or spherical in shape. A spherical particle with an average particle diameter of 5 to 20 μm is especially suitable.

The mixing ratio of this silicone acrylic copolymer is 2 to 14 pts.wt. or preferably 2.5 to 10 pts.wt. per 100 pts.wt. of the vinyl chloride resin (soft polyvinyl chloride).

If the content of the silicone acrylic copolymer is less than 1.5 pts.wt., wear resistance cannot be improved. If the content exceeds 15 pts.wt., on the other hand, the bendability of the film 1 is adversely affected.

The surface treatment layer 1a formed on the surface side of the film 1 is a durable aqueous treatment layer formed by applying a surface treatment agent obtained by mixing a polycarbonate urethane and an ester urethane and crosslinking the mixture with a carbodiimide.

That is, the surface treatment agent applied to the surface of the film 1 includes a mixture of a polycarbonate urethane and an ester urethane that has been crosslinked with a carbodiimide group-containing crosslinking agent.

An aqueous crosslinking agent containing a carbodiimide group may be used alone as the crosslinking agent, but preferably an aqueous crosslinking agent containing a carbodiimide group is used in combination with an isocyanate based crosslinking agent.

An aqueous polycarbonate polyurethane represented by chemical formula 2 is preferably used as the polycarbonate urethane. The molecular weight is at least 70,000, or preferably 70,000 to 140,000.

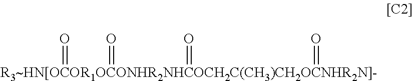

In particular, an anionic aqueous polyurethane resin having polycarbonate in the resin framework or the like can be used as the aqueous polycarbonate polyurethane.

Specific examples of this aqueous polycarbonate polyurethane include WD78-143 (made by Stahl).

An aqueous polyester polyurethane represented by chemical formula 3 is preferably used as the ester urethane. The molecular weight is at least 70,000, or preferably 70,000 to 140,000.

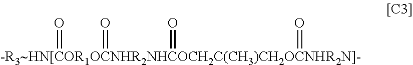

Specific examples of this aqueous polyester polyurethane include WD78-253/PES (made by Stahl).

An aliphatic systemaqueous cross-linking agent containing a carbodiimide group represented by chemical formula 4 is preferably used as the carbodiimide group-containing aqueous crosslinking agent.

R1-N═C═N—R2 [C4]

Specific examples of this aliphatic systemaqueous cross-linking agent containing a carbodiimide group include XR13-621 (made by Stahl).

An alicyclic crosslinking agent or aliphatic system crosslinking agent represented by chemical formula 5 is preferably used as the isocyanate based crosslinking agent.

R1-N═C═O [C5]

Specific examples of this isocyanate based crosslinking agent include XR28-404 (made by Stahl).

Specifically, the anionic aqueous polyurethane resin is produced by a known method such as a method in which an organic polyisocyanate (A), a polyol (B) and a polyol (C) having a carboxyl group or sulfonate group in the molecule are reacted together with a trifunctional chain extender as necessary to produce a prepolymer, and this is then added to water which has been compounded with a neutralizing agent and an emulsifier as necessary, to water-disperse the prepolymer and elongate the chains.

A compound capable of reacting with the anionic group may be compounded at any stage in the production of the water-based polyurethane resin composition. For example, it may be compounded at the polyurethane prepolymer stage, or it may be compounded with the anionic aqueous polyurethane resin.

The organic polyisocyanate (A) used to produce the anionic aqueous polyurethane resin may be an aliphatic, alicyclic or aromatic polyisocyanate, and specific examples include tetramethylene diisocyanate, hexamethylene diisocyanate, dodecamethylene diisocyanate, trimethylhexamethylene diisocyanate, lysine diisocyanate ester, 1,3-cyclohexylene diisocyanate, 1,4-cyclohexylene diisocyanate, 4,4′-dicyclohexylmethane diisocyanate, 2,4′-dicyclohexylmethane diisocyanate, 2,2′-dicyclohexylmethane diisocyanate, isophorone diisocyanate, 2,4-tolylene diisocyanate, 2,6-tolylene diisocyanate, 4,4′-diphenylmethane diisocyanate, 2,4′-diphenylmethane diisocyanate, 2,2′-diphenylmethane diisocyanate, polyphenyl polymethylene polyisocyanate, m-phenylene diisocyanate, p-phenylene diisocyanate, xylylene diisocyanate, tetramethylxylylene diisocyanate, 3,3′-dimethoxy-4,4′-biphenylene diisocyanate, 1,5-naphthalene diisocyanate, 1,5-tetrahydronaphthalene diisocyanate and the like.

The organic polyisocyanate (A) is used in the amount of preferably 0.5 to 2 equivalents or more preferably 0.8 to 1.5 equivalents of the total of the polyol (B), the polyol (C) having a carboxyl group or sulfonate group and the active hydrogen in the chain extender. If the isocyanate is used in the amount of less than 0.5 equivalents the molecular weight will be too small, while if it is used in the amount of more than 2 equivalents many urea bonds will be produced when water is added, potentially detracting from the properties of the resin.

The polyol compound (B) used in the anionic aqueous polyurethane resin may be a commonly used polyester polyol, polyether polyol, polycarbonate polyol, polycaprolactone polyol or the like, and these may be used alone or multiple kinds may be combined. A polycarbonate polyol is desirable for achieving a balance of performance including hydrolyzability, chemical resistance, wear resistance, bendability, aging properties and the like.

Examples of the polycarbonate polyol include polyester polyols that are condensation reaction products of dibasic acids such as adipic acid and phthalic acid with glycols such as ethylene glycol and 1,4-butanediol; and polycarbonate polyols that are reaction products of glycols with carbonates such as ethylene carbonate.

Examples of the polyester polyols include polyester polyols that are condensation products of ethylene glycol, dithylene glycol, triethylene glycol, 1,2-propylene glycol, 1,3-propylene glycol, 1,2-butylene glycol, 1,3-butylene glycol, 1,4-butylene glycol, neopentyl glycol, 1,6-hexanediol, hexamethylene glycol, 3-methylpentanediol, trimethylolethane, trimethylolpropane, hexanetriol, glycerin, pentaerythritol, sorbitol, hydrogenated bisphenol A or polyols composed of alkylene oxide adducts and low-molecular-weight polyols having two or more such active hydrogens with carbonic acid or polybasic acids such as succinic acid, glutaric acid, adipic acid, sebacic acid, dimer acid, phthalic acid, isophthalic acid, terephthalic acid, trimellitic acid, tetrahydrophthalic acid, endomethylenetetrahydrophthalic acid, hexahydrophthalic acid and the like.

The average molecular weight of the high-molecular-weight polyol is at least 70,000 or preferably 70,000 to 140,000, and molecular weights below 50,000 are undesirable because elongation is reduced. On the other hand, with molecular weights over 150,000 operating problems occur because the resulting anionic aqueous polyurethane resin has a higher viscosity.

Examples of the polyol (C) having a carboxyl group or sulfonate group include 2,2-dimethylolpropionic acid, 2,2-dimethylolbutyric acid, 2,2-dimethylolvaleric acid, 1,4-butanediol-2-sulfonic acid and the like. The amount of these polyols (C) having carboxyl groups or sulfonate groups that is used depends on the kind of polyol and polyisocyanate, but is normally 0.5 to 50 mass % or preferably 1 to 30 mass % of all of the reaction components constituting the anionic aqueous polyurethane resin. If the polyol (C) is used in the amount of less than 0.5 mass %, storage stability declines, while if the amount exceeds 50 mass % the properties may be adversely affected.

Examples of the neutralizing agent used to neutralize the prepolymer include ammonia, organic amines such as trimethylamine, triethylamine, tripropylamine, tributylamine, N-methyldiethanolamine and triethanolamine, and inorganic bases such as sodium hydroxide, potassium hydroxide and ammonia, and these are used in amounts sufficient to neutralize the carboxyl groups or sulfonate groups.

A well-known common anionic surfactant, nonionic surfactant, cationic surfactant, amphoteric surfactant, polymeric surfactant, reactive surfactant or the like used in water-dispersible polyurethane resins may be used as the emulsifier. Of these, an anionic surfactant, nonionic surfactant or cationic surfactant is preferred because these provide good emulsification at a low cost.

A chain extender may also be used in producing the anionic aqueous polyurethane resin. A commonly used chain extender may be used as this chain extender, and examples include low-molecular-weight polyamine compounds and low-molecular-weight polyol compounds with average molecular weights below 200.

Examples of the chain extender include polyols such as ethylene glycol, 1,2-propylene glycol, 1,3-propylene glycol, 1,2-butanediol, 1,3-butanediol, 1,4-butanediol, 2,2-dimethyl-1,3-propanediol, 3-methylpentanediol, dimethylolpropionic acid, trimethylol propane and pentaerythritol, amines such as ethylenediamine, propylenediamine, hexamethylenediamine, tolylenediamine, xylylenediamine, diaminodiphenylamine, diaminocyclohexylmethane, piperazine, 2-methylpiperazine, isophoronediamine, melamine, succinic dihydrazide, adipic dihydrazide and phthalic dihydrazide, and water and the like. One of these chain extenders alone or a combination of two or more may be used, and the amount that is used depends on the molecular weight of the target anionic aqueous polyurethane resin, but is normally 0.1 to 2 equivalents or preferably 0.5 to 0.9 equivalents of active hydrogen reacting with the NCO in the prepolymer. If the active hydrogen of the chain extender is less than 0.1 equivalents the molecular weight will be too low, while if it exceeds 2 equivalents there will be a residue of unreacted chain extender, potentially detracting from the physical properties of the resulting product. Moreover, an anionic aqueous polyurethane resin with excellent film properties may be obtained if a trifunctional or higher low-molecular-weight polyol or low-molecular-weight polyamine is partly used as the chain extender.

A solvent is also used as necessary to produce the prepolymer. The solvent is preferably one that is inactive in the reaction and has a high affinity for water, such as acetone, methyl ethyl ketone, dioxane, tetrahydrofuran, N-methyl-2-pyrrolidone or the like. These solvents are normally used in the amount of preferably 3 to 100 mass % of the total amount of the raw materials used to produce the prepolymer. Of these solvents, a solvent with a boiling point of 100° C. or less is preferably distilled off under reduced pressure after synthesis of the prepolymer.

As discussed above, the production of anionic aqueous polyurethane resins from these raw materials is well known, and the order of addition of these raw materials can be changed appropriately, or they may be divided and added in batches.

An anionic aqueous polyurethane resin obtained in this way is normally prepared so that the resin solids component constitutes 20 to 80 mass %, or preferably 25 to 55 mass % of the emulsion as a whole. If the resin solids component is less than 20 mass %, the resulting film will have poor physical properties, the drying time will be longer and the mechanical strength will be inadequate, while if it exceeds 80 mass % the resin will be more viscous and a uniform film will not be obtained.

In the water-based polyurethane resin composition, at least some of the anionic groups of the anionic aqueous polyurethane resin are blocked with a compound capable of reacting with anionic groups (specifically, with carboxyl groups or sulfonic groups). Specific examples of compounds capable of reacting with anionic groups (hereunder called sequestrants) include carbodiimide compounds, oxazoline compounds, epoxy compounds, aziridine compounds and the like. Of these, a carbodiimide compound that reacts readily with anionic groups is preferred.

The carbodiimide compound is preferably a compound obtained by reacting an organic diisocyanate in the presence of a catalyst such as a phospholene compound, metal carbonyl complex compound or phosphate ester that promotes carbodiimidization. Specific examples include dipropyl carbodiimide, dihexyl carbodiimide, dicyclohexyl carbodiimide, di-p-trioyl carbodiimide and triisopropylbenzene polycarbodiimide, and an aqueous carbodiimide compound having hydrophilicity is preferred.

The mixing ratio of the surface treatment agent applied to the surface of the film 1 is 15 to 55 pts.wt., or preferably 20 to 50 pts.wt. of ester urethane (aqueous polyester polyurethane) per 100 pts.wt. of polycarbonate urethane (aqueous polycarbonate polyurethane).

If the content of the ester urethane is less than 10 pts.wt., plasticizer exert influence, and chemical resistance to oleic acid cannot be improved. If the content exceeds 60 pts.wt., on the other hand, adequate wear resistance cannot be obtained.

When the carbodiimide group-containing aqueous crosslinking agent is added to the surface treatment agent, the added amount of the carbodiimide (aliphatic carbodiimide) is 3 to 12 pts.wt., or preferably 4 to 8 pts.wt. of the carbodiimide per 100 pts.wt. of the polycarbonate urethane.

If the content of the carbodiimide is less than 2 pts.wt., wear resistance and chemical resistance to oleic acid cannot be improved. If the content exceeds 13 pts.wt., on the other hand, cracks occur in the surface layer when it is bent.

When an isocyanate based crosslinking agent is used in combination with the carbodiimide group-containing aqueous crosslinking agent, the content of the isocyanate (aliphatic isocyanate) is preferably 0 to 8 pts.wt. per 100 pts.wt. of the polycarbonate urethane.

If the content of the isocyanate exceeds 9 pts.wt., cracks occur in the surface layer when it is bent.

Regarding the method for producing the synthetic resin leather A of an embodiment of the invention, the method includes a film molding step in which a film 1 is molded constituted primarily of a vinyl chloride resin; a base material adhering step in which a base material 2 is made to adhere to the rear surface side of the film 1; and a surface treatment step in which a surface treatment agent including a mixture of a polycarbonate urethane (aqueous polycarbonate polyurethane) and an ester urethane (aqueous polyester polyurethane) crosslinked with a carbodiimide (aliphatic carbodiimide) group-containing aqueous crosslinking agent is applied to the surface of the molded film 1, in order to form a surface treatment layer 1a.

In the film molding step, the film 1 constituted primarily of a vinyl chloride resin is molded by calendar molding, extrusion molding or the like.

In the base material adhering step, either an adhesive is applied either to the rear surface side of the film 1 or to one side of the base material 2, and the film 1 and base material 2 are made to adhere indirectly via the adhesion layer 3 as shown in FIG. 1 and FIG. 2, or else the film 1 and base material 2 are made to adhere and integrated together directly without the use of an adhesion layer 3 as shown in FIG. 3.

In the surface treatment step, an aqueous surface treatment agent is applied to the surface of the molded film 1, and dried to form a surface treatment layer 1a. The surface treatment agent may be applied by an ordinary printing method such as gravure direct printing, gravure offset printing or screen printing, or by a coating method such as gravure coating, roll coating, and comma coating.

The surface-treated film 1 with the base material 2 attached thereto may also be subjected to a foaming step or drawing step as necessary. This serves to form a relief pattern 4 such as a grain pattern having convex parts 4a and concave parts 4b on the surface of the film 1 and on the surface treatment layer 1a.

With such a synthetic resin leather A and producing method therefor of embodiments of the present invention, a surface treatment layer 1a with excellent bendability, wear resistance and oleic acid resistance is formed by applying a surface treatment agent including a mixture of a polycarbonate urethane and an ester urethane crosslinked with a carbodiimide to the surface side of a film 1 constituted primarily of a vinyl chloride resin.

Consequently, a synthetic resin leather can be provided that is both strong and exhibits highly flexibility, is resistant to wear caused by repeated rubbing, and also has chemical resistance (oleic acid resistance) with respect to contact with the human body.

As a result, in comparison with conventional products that are liable to peeling due to repeated rubbing of convex parts of the skin layer and have poor chemical resistance with respect to adherence of sebum, perspiration, hydrating lotions and the like from the human body, peeling does not occur even when there is repeated rubbing due to contact between the surface treatment layer and other objects such as the user's skin and clothing over a long period of time, adequate wear resistance can be maintained, and at the same time chemical resistance can be maintained with respect to higher fatty acids such as oleic acid, which are often contained in sebum, perspiration, hydrating lotions and the like.

It is particularly desirable to use an isocyanate based crosslinking agent in combination with a carbodiimide group-containing aqueous crosslinking agent as the crosslinking agent.

This serves to increase the wear resistance of the surface treatment layer 1a while maintaining the cold-resistant bendability of the surface treatment layer 1a.

Consequently, the surface treatment layer 1a can be made tough.

Durability can be improved as a result.

### EXAMPLES

Examples of the present invention are explained below.

### Examples 1 to 12 and Comparative Examples 1 to 8

In Examples 1 to 12 shown in Table 1 and Comparative Examples 1 to 8 shown in Table 2, the described components were compounded in the proportions shown, and calendar molded, thereby molding a non-foam layer 11 with a thickness of 0.3 mm and a foam layer 12 with a thickness of 0.6 mm. The non-foam layer 11 and foam layer 12 and a base material 2 (two-component polyurethane adhesive applied to a pile knitted fabric knitted from 83T crimped yarn of 100% polyester) were superimposed, heated, foamed, and pressed with a drawing roll and a rubber roll to draw the material while at the same time causing the foam layer 12 and base material 2 to adhere together, to obtain a synthetic resin leather A (A3) with a relief pattern 4 as shown in FIG. 3.

Specifically, for the non-foam layer 11 of the film 1, a combined total of 80 pts.wt. of a plasticizer (diisodecyl phthalate: DIDP), a plasticizer (epoxidized soybean oil), a heat stabilizer (barium-zinc mixed stabilizer), a filler (calcium carbonate), a flame retardant (antimony trioxide), a pigment and the like are compounded per 100 pts.wt. of a soft polyvinyl chloride (straight resin with a polymerization degree of 1100), and molded to a thickness of 0.3 mm.

For the foam layer 12 of the film 1, 75 pts.wt. of a plasticizer (diisodecyl phthalate: DIDP), 2 pts.wt. of a plasticizer (epoxidized soybean oil), 3 pts.wt. of a heat stabilizer (barium-zinc mixed stabilizer), 5 pts.wt. of a filler (calcium carbonate), 15 pts.wt. of a flame retardant (antimony trioxide), 5 pts.wt. of a foaming agent (azodicarbonamide) and a small amount of a pigment are compounded per 100 pts.wt. of a polyvinyl chloride (straight resin with a polymerization degree of 1100), and molded to a thickness of 0.25 mm before foaming and 0.6 mm after foaming.

Moreover, the aforementioned silicone acrylic copolymer is also compounded as a wear improver in at least the non-foam layer 11 in the film 1.

On the surface of the film 1 in Examples 1 to 12 and Comparative Examples 1 to 8, a surface treatment agent obtained by crosslinking a mixture of an aqueous polycarbonate polyurethane (WD78-143 made by Stahl) represented by chemical formula 2 as a polycarbonate urethane and

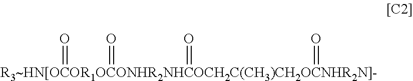

an aqueous polyester polyurethane (WD78-253/PES made by Stahl) represented by chemical formula 3 as an ester urethane

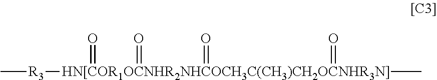

with an aliphatic systemaqueous cross-linking agent containing a carbodiimide group (XR13-621 made by Stahl) represented by chemical formula 4 as a carbodiimide group-containing aqueous crosslinking agent

R1-N═C═N—R2 [C4]

is applied to a film thickness of 20 μm, in order to forma surface treatment layer 1a.

In Examples 5, 6, 10 and 12 and Comparative Example 8 in particular, a combination of an aliphatic system aqueous cross-linking agent containing a carbodiimide group and an aliphatic system crosslinking agent (XR28-404 made by Stahl) represented by chemical formula 5 as an isocyanate based crosslinking agent was employed

R1-N═C═O [C5]

to perform crosslinking.

In Examples 2 and 4 to 12 and Comparative Examples 3 to 8, in the non-foam layer 11 of the film 1, the silicone acrylic copolymer represented by chemical formula 1 (silicone weight ratio 70%, molecular weight 250,000) is added in the amount of 5 pts.wt per 100 pts.wt. of the polyvinyl chloride (straight resin with a polymerization degree of 1100)

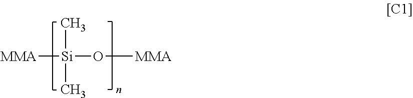

to have a common configuration.

Examples 1 to 3, 5, 6 and 9 to 12 and Comparative Examples 1, 2 and 6 to 8 have a common configuration in which the ester urethane (aqueous polyester polyurethane) is added in the amount of 30 pts.wt. per 100 pts.wt. of a polycarbonate urethane (aqueous polycarbonate polyurethane) in the surface treatment layer 1a.

Examples 1 to 8 and Comparative Examples 1 to 5 and 8 have a common configuration in which the carbodiimide (aliphatic carbodiimide) is added in the amount of 4 pts.wt. per 100 pts.wt of the polycarbonate urethane (aqueous polycarbonate polyurethane) in the surface treatment layer 1a.

In the film 1 (non-foam layer 11) of Example 1, 2.5 pts.wt. of a silicone acrylic copolymer are added per 100 pts.wt. of the polyvinyl chloride (straight resin with a polymerization degree of 1100).

In the film 1 (non-foam layer 11) of Example 3, 10 pts.wt. of the silicone acrylic copolymer are added per 100 pts.wt. of the polyvinyl chloride (straight resin with a polymerization degree of 1100).

In the surface treatment layer 1a of Example 4, 20 pts.wt. of the ester urethane (aqueous polyester polyurethane) are added per 100 pts.wt. of the polycarbonate urethane (aqueous polycarbonate polyurethane).

In the surface treatment layer 1a of Example 7, 40 pts.wt. of the ester urethane (aqueous polyester polyurethane) are added per 100 pts.wt. of the polycarbonate urethane (aqueous polycarbonate polyurethane).

In the surface treatment layer 1a of Example 8, 50 pts.wt. of the ester urethane (aqueous polyester polyurethane) are added per 100 pts.wt. of the polycarbonate urethane (aqueous polycarbonate polyurethane).

In the surface treatment layers 1a of Examples 9 and 10, 8 pts.wt. of the carbodiimide (aliphatic carbodiimide) are added per 100 pts.wt. of the polycarbonate urethane (aqueous polycarbonate polyurethane).

In the surface treatment layers 1a of Examples 11 and 12, 12 pts.wt. of the carbodiimide (aliphatic carbodiimide) are added per 100 pts.wt. of the polycarbonate urethane (aqueous polycarbonate polyurethane).

In the surface treatment layers 1a of Examples 5, 10 and 12, 4 pts.wt. of the isocyanate based crosslinking agent (aliphatic system crosslinking agent) are added per 100 pts.wt. of the polycarbonate urethane (aqueous polycarbonate polyurethane).

In the surface treatment layer 1a of Example 6, 8 pts.wt. of the isocyanate based crosslinking agent (aliphatic system crosslinking agent) are added per 100 pts.wt. of the polycarbonate urethane (aqueous polycarbonate polyurethane).

Comparative Example 1 differs from. Example 1 in that the amount of the silicone acrylic copolymer mixed with the vinyl chloride resin in the film 1 (non-foam layer 11) is smaller.

Specifically, 1.5 pts.wt. of the silicone acrylic copolymer are added per 100 pts.wt. of the polyvinyl chloride (straight resin with a polymerization degree of 1100) in the film 1 (non-foam layer 11) of the Comparative Example 1.

Comparative Example 2 differs from. Example 3 in that the amount of the silicone acrylic copolymer mixed with the vinyl chloride resin in the film 1 (non-foam layer 11) is greater.

Specifically, 15 pts.wt. of the silicone acrylic copolymer are added per 100 pts.wt. of the polyvinyl chloride (straight resin with a polymerization degree of 1100) in the film 1 (non-foam layer 11) of the Comparative Example 2.

Comparative Examples 3 and 4 differ from Example 4 in that the amount of the ester urethane mixed with the polycarbonate urethane (aqueous polycarbonate polyurethane) in the surface treatment layer 1a is smaller.

Specifically, no ester urethane is added in the surface treatment layer 1a of Comparative Example 3, and 10 pts.wt. of ester urethane (aqueous polyester polyurethane) are added per 100 pts.wt. of the polycarbonate urethane in the surface treatment layer 1a of Comparative Example 4.

Comparative Example 5 differs from. Example 6 in that the amount of the ester urethane (aqueous polyester polyurethane) mixed with the polycarbonate urethane (aqueous polycarbonate polyurethane) is greater in the surface treatment layer 1a.

Specifically, 60 pts.wt. of the ester urethane (aqueous polyester polyurethane) are added per 100 pts.wt. of the polycarbonate urethane in the surface treatment layer 1a of Comparative Example 5.

Comparative Example 6 differs from. Example 2 in that the amount of the carbodiimide (aliphatic carbodiimide) mixed with the polycarbonate urethane (aqueous polycarbonate polyurethane) is smaller in the surface treatment layer 1a.

Specifically, 2 pts.wt. of the carbodiimide (aliphatic carbodiimide) are added per 100 pts.wt. of the polycarbonate urethane in the surface treatment layer 1a of Comparative Example 6.

Comparative Example 7 differs from Example 11 in that the amount of the carbodiimide (aliphatic carbodiimide) mixed with the polycarbonate urethane (aqueous polycarbonate polyurethane) in the surface treatment layer 1a is greater.

Specifically, 13 pts.wt. of the carbodiimide (aliphatic carbodiimide) are added per 100 pts.wt. of the polycarbonate urethane (aqueous polycarbonate polyurethane) in the surface treatment layer 1a of Comparative Example 7.

Comparative Example 8 differs from Example 6 in that the amount of the isocyanate (aliphatic isocyanate) mixed with the carbodiimide (aliphatic carbodiimide) in the surface treatment layer 1a is greater.

Specifically, 9 pts.wt. of the isocyanate (aliphatic isocyanate) are added per 4 pts.wt. of the carbodiimide (aliphatic carbodiimide) in the surface treatment layer 1a of Comparative Example 8.

The evaluation results shown in Table 1 and Table 2 (cold-resistant bendability, wear resistance (1), wear resistance (2), chemical resistance, workability) are based on the following criteria.

To evaluate “cold-resistant bendability”, using a DeMattia flexing tester, a repeated bending load was applied with a fixed stroke to a test piece (70 mm×40 mm) in accordance with JIS K6260, and the presence or absence of cracking after repeated bending 30,000 times at −10° C. was evaluated according to a 3-level standard.

In the evaluation results for “cold-resistant bendability”, ◯ means no cracking of the film 1 after repeated bending 40,000 times, Δ means no cracking of the film 1 after repeated bending 30,000 times, and X means that cracking of the film 1 occurred after repeated bending 25,000 times.

To evaluate “wear resistance (1)”, using a Gakushin-Type Rubbing Tester conforming to JIS L0823 (Friction Testers for color fastness tests), a friction test was performed with JIS L3102 #6 cotton canvas under a load of 1 kg, and the presence or absence of wear after 30,000 passes was evaluated according to a 6-level standard. A test piece with a 10 mm wide by 3 mm long urethane foam pasted thereon was used.

In the evaluation results for “wear resistance (1)”, ⊗++ means no scraping of the treatment layer of the film 1 after 40,000 or more passes, ⊗+ means no scraping of the treatment layer of the film 1 after 35,000 passes, ⊗ means no scraping of the treatment layer of the film 1 after 30,000 passes, ◯ means some scraping of the treatment layer after 30,000 passes, Δ means some scraping of the treatment layer after 20,000 passes, and X means tearing of the film 1 after 20,000 passes.

To evaluate “wear resistance (2)”, using a Gakushin-Type Rubbing Tester conforming to JIS L0823 (Friction Testers for color fastness tests) as in the evaluation of “wear resistance (1)”, a friction test was performed with JIS L3102 #6 cotton canvas under a load of 1 kg, and the amount of scraping of the film 1 after 10,000 passes was evaluated using a 25 mm wide by 70 mm long test piece and graded according to a 6-level standard.

In the evaluation results for “friction resistance (2)”, ⊗++ means 0.010 g of scraping or less, ⊗+ means 0.010 to 0.015 g, ⊗ means 0.015 to 0.02 g, ◯ means 0.02 to 0.025 g, Δ means 0.025 to 0.03 g, and X means 0.03 g or more.

To evaluate “chemical resistance”, four pieces of filter paper were laid over a test piece obtained in any size, and 1.2 mL of oleic acid was dripped thereon. This was sealed in aluminum foil, left for 24 hours in an 80° C. environment, removed, and wiped as though tapping the surface, and bubbling and tearing of the test piece and peeling of the surface treatment layer were evaluated visually and graded according to a 4-level standard.

In the evaluation results for “chemical resistance”, └ means no peeling at all of the surface treatment layer 1a, ◯ means almost no peeling of the surface treatment layer 1a, Δ means partial peeling of the surface treatment layer 1a, and X means almost complete peeling of the surface treatment layer 1a.

To evaluate “workability”, calendar processing was evaluated according to a 3-level standard at a rolling temperature of 150° C.

In the evaluation results for “workability”, ◯ mean good calendar processing was possible, Δ means calendar processing was possible, and X means calendar processing was not possible because lubricity was too high.

TABLE 1

| | | Examples | | | | | | | | | | | |
|---|---|---|---|---|---|---|---|---|---|---|---|---|---|
| | | 1 | 2 | 3 | 4 | 5 | 6 | 7 | 8 | 9 | 10 | 11 | 12 |
| Film | Vinyl chloride resin | 100 | 100 | 100 | 100 | 100 | 100 | 100 | 100 | 100 | 100 | 100 | 100 |
| | Silcone-acrylic | 2.5 | 5 | 10 | 5 | 5 | 5 | 5 | 5 | 5 | 5 | 5 | 5 |
| | copolymer | | | | | | | | | | | | |
| Surface | Polycarbonate | 100 | 100 | 100 | 100 | 100 | 100 | 100 | 100 | 100 | 100 | 100 | 100 |
| Treatment | urethane | | | | | | | | | | | | |
| layer | Ester urethane | 30 | 30 | 30 | 20 | 30 | 30 | 40 | 50 | 30 | 30 | 30 | 30 |
| | Carbodiimide | 4 | 4 | 4 | 4 | 4 | 4 | 4 | 4 | 8 | 8 | 12 | 12 |
| | Isocyanate | 0 | 0 | 0 | 0 | 4 | 8 | 0 | 0 | 0 | 4 | 0 | 4 |
| Evaluation | Cold-resistant | ◯ | ◯ | ◯ | ◯ | ◯ | Δ | ◯ | ◯ | ◯ | ◯ | Δ | Δ |
| results | bendability | | | | | | | | | | | | |
| | Wear resistance (1) | ⊗ | ⊗ | ⊗ | ◯ | ⊗++ | ⊗+ | ⊗ | Δ | ⊗+ | ⊗++ | ⊗+ | ⊗++ |
| | Wear resistance (2) | Δ | ⊗ | ⊗ | ◯ | ⊗+ | ⊗+ | ⊗ | Δ | ⊗+ | ⊗++ | ⊗+ | ⊗++ |
| | Chemical resistance | Δ | ◯ | ◯ | Δ | ◯ | ◯ | ◯ | ⊗ | ◯ | ◯ | ◯ | ◯ |
| | Workability | ◯ | ◯ | ◯ | ◯ | ◯ | ◯ | ◯ | ◯ | ◯ | ◯ | ◯ | ◯ |
| | General evaluation | Δ | ⊗ | ⊗ | ◯ | ⊗+ | Δ | ⊗ | Δ | ⊗+ | ⊗++ | Δ | Δ |

TABLE 2

| | | Examples | | | | | | | |
|---|---|---|---|---|---|---|---|---|---|
| | | 1 | 2 | 3 | 4 | 5 | 6 | 7 | 8 |
| Film | Vinyl chloride resin | 100 | 100 | 100 | 100 | 100 | 100 | 100 | 100 |
| | Silcone-acrylic | 1.5 | 15 | 5 | 5 | 5 | 5 | 5 | 5 |
| | copolymer | | | | | | | | |
| Surface | Polycarbonate | 100 | 100 | 100 | 100 | 100 | 100 | 100 | 100 |
| Treatment | urethane | | | | | | | | |
| layer | Ester urethane | 30 | 30 | 0 | 10 | 60 | 30 | 30 | 30 |
| | Carbodiimide | 4 | 4 | 4 | 4 | 4 | 2 | 13 | 4 |
| | Isocyanate | 0 | 0 | 0 | 0 | 0 | 0 | 0 | 9 |
| Evaluation | Cold-resistant | ◯ | X | ◯ | ◯ | ◯ | ◯ | X | X |
| results | bendability | | | | | | | | |
| | Wear resistance (1) | ⊗ | ⊗ | X | ◯ | X | X | ⊗ | ⊗ |
| | Wear resistance (2) | X | ⊗ | Δ | Δ | Δ | Δ | Δ | Δ |
| | Chemical resistance | ◯ | ◯ | X | X | ◯ | X | ◯ | ◯ |
| | Workability | ◯ | X | ◯ | ◯ | ◯ | ◯ | ◯ | ◯ |
| | General evaluation | X | X | X | X | X | X | X | X |

### [Evaluation Results]

Examples 1 to 12 with Comparative Examples 1 to 8, good evaluation results were obtained in Examples 1 to 12 in all the categories of cold-resistant bendability, wear resistance (1), wear resistance (2), chemical resistance and workability.

As shown by these evaluation results, in Examples 1 to 12 adequate wear resistance is maintained, with no peeling of the convex parts 4a of the surface treatment layer 1a even after repeated contact between the surface treatment layer 1a of the film 1 with other objects such as the user's skin and clothing over a long period of time. At the same time, it was also possible to maintain chemical resistance with respect to higher fatty acids such as oleic acid, which are often contained in sebum, perspiration, hydrating lotions and the like.

In Examples 2, 3 and 7 in particular, wear resistance (1) and wear resistance (2) were further improved and the best general evaluations were obtained when the added amount of the silicone acrylic copolymer was 5 pts.wt. per 100 pts.wt. of the polyvinyl chloride (straight resin with a polymerization degree of 1100), when the added amount of the ester urethane (aqueous polyester polyurethane) was 30 to 40 pts.wt. per 100 pts.wt. of the polycarbonate urethane (aqueous polycarbonate polyurethane), and when the added amount of the carbodiimide (aliphatic carbodiimide) was 4 to 8 pts.wt. per 100 pts.wt. of the polycarbonate urethane (aqueous polycarbonate polyurethane).

In Examples 5, 9, and 10, meanwhile, wear resistance (1) and wear resistance (2) were further improved when the added amount of the isocyanate based crosslinking agent (aliphatic system crosslinking agent) was 4 to 8 pts.wt. Out of these, the best general evaluation was obtained in Example 10 using 8 pts.wt. of the aliphatic carbodiimide and 4 pts.wt. of the aliphatic system crosslinking agent.

By contrast, in Comparative Examples 1 to 8 poor evaluation results were obtained in all the categories of cold-resistant bendability, wear resistance (1), wear resistance (2), chemical resistance and workability.

Specifically, in Comparative Example 1 the evaluation results for scraping during wear (wear resistance (2)) were extremely poor because the amount of the silicone acrylic copolymer mixed with the vinyl chloride resin was smaller than in Example 1.

In Comparative Example 2, the film 1 cracked due to repeated bending in the cold-resistant bendability test and a poor evaluation result was obtained because the amount of the silicone acrylic copolymer mixed with the vinyl chloride resin was greater than in Example 3. The evaluation results were also poor in the workability test because calendar processing was impossible due to high lubricity.

In Comparative Example 3, cracking occurred and a poor evaluation result was obtained for wear resistance (1) because no ester urethane (aqueous polyester polyurethane) was added to the polycarbonate urethane (aqueous polycarbonate polyurethane) in the surface treatment layer 1a. In the chemical resistance evaluation, most of the surface treatment layer 1a peeled, and the evaluation result was poor.

In Comparative Example 4, most of the surface treatment layer 1a peeled and a poor result was obtained in the chemical resistance evaluation because the amount of the ester urethane (aqueous polyester polyurethane) mixed with the polycarbonate urethane (aqueous polycarbonate polyurethane) in the surface treatment layer 1a was smaller than in Example 4.

In Comparative Example 5, peeling occurred and a poor evaluation result was obtained for wear resistance (1) because the amount of the ester urethane (aqueous polyester polyurethane) mixed with the polycarbonate urethane (aqueous polycarbonate polyurethane) in the surface treatment layer 1a was greater than in Example 6.

In Comparative Example 6, peeling occurred and a poor evaluation result was obtained for wear resistance (1) because the amount of the carbodiimide (aliphatic carbodiimide) mixed with the polycarbonate urethane (aqueous polycarbonate polyurethane) in the surface treatment layer 1a was smaller than in Example 2. In the chemical resistance evaluation, moreover, most of the surface treatment layer 1a peeled and the evaluation result was poor.

In Comparative Example 7, cracks occurred and a poor evaluation result was obtained in the cold-resistant bendability evaluation because the amount of the carbodiimide (aliphatic carbodiimide) mixed with the polycarbonate urethane (aqueous polycarbonate polyurethane) in the surface treatment layer 1a was greater than in Example 7.

In Comparative Example 8, cracks occurred and a poor evaluation result was obtained in the cold-resistant bendability evaluation because the amount mixed with the carbodiimide (aliphatic carbodiimide) in the surface treatment layer 1a was greater than in Example 6.

In Examples 1 to 12 and Comparative Example 1 to 8 above, evaluations were performed on a synthetic resin leather A (A3) shown in FIG. 3 having a foam layer 12 that adheres directly to the base material 2, but this is not a limitation, and similar evaluation results are obtained using the synthetic resin leather A (A1) shown in FIG. 1 having no foam layer 12, or a synthetic resin leather A (A2) having a foam layer 12 that adheres indirectly to the base material 2 via an adhesion layer 3.

### REFERENCE SIGNS LIST

A, A1, A2, A3 Synthetic resin leather
1 Film
1a Surface treatment layer
11 Non-foam layer 11
12 Foam layer
2 Base material
3 Adhesion layer
4 Relief pattern
4a Convex part
4b Concave part

1. A synthetic resin leather comprising a surface treatment layer formed on a surface side of a film constituted primarily of a vinyl chloride resin, wherein
said surface treatment layer is formed by applying a surface treatment agent including a mixture of a polycarbonate urethane and an ester urethane crosslinked with a carbodiimide group-containing crosslinking agent.

2. The synthetic resin leather according to claim 1, wherein said crosslinking agent is a combination of a carbodiimide group-containing aqueous crosslinking agent and an isocyanate based crosslinking agent.

3. The synthetic resin leather according to claim 1, wherein in said surface treatment agent, 20 to 50 pts.wt. of said ester urethane are mixed per 100 pts.wt. of said polycarbonate urethane.

4. The synthetic resin leather according to claim 1, wherein said film is a mixed resin layer comprising a vinyl chloride resin and a silicone acrylic copolymer, in which 2.5 to 10 pts.wt. of said silicone acrylic copolymer are mixed per 100 pts.wt. of said vinyl chloride resin.

5. A method for producing a synthetic resin leather,
the method comprising:
a film molding step in which a film constituted primarily of a vinyl chloride resin is molded;
a surface treatment step in which a surface treatment agent including a mixture of a polycarbonate urethane and an ester urethane crosslinked either with a carbodiimide group-containing aqueous crosslinking agent or with said carbodiimide group-containing aqueous crosslinking agent and an isocyanate based crosslinking agent is applied to a surface of said molded film, in order to form a surface treatment layer; and
a base material adhering step in which a base material is made to adhere to a rear surface side of said film.

6. The method for producing a synthetic resin leather according to claim 5, wherein the film molding step is performed by calendar molding.

7. The synthetic resin leather according to claim 2, wherein in said surface treatment agent, 20 to 50 pts.wt. of said ester urethane are mixed per 100 pts.wt. of said polycarbonate urethane.

8. The synthetic resin leather according to claim 2, wherein said film is a mixed resin layer comprising a vinyl chloride resin and a silicone acrylic copolymer, in which 2.5 to 10 pts.wt. of said silicone acrylic copolymer are mixed per 100 pts.wt. of said vinyl chloride resin.

9. The synthetic resin leather according to claim 3, wherein said film is a mixed resin layer comprising a vinyl chloride resin and a silicone acrylic copolymer, in which 2.5 to 10 pts.wt. of said silicone acrylic copolymer are mixed per 100 pts.wt. of said vinyl chloride resin.

10. The synthetic resin leather according to claim 7, wherein said film is a mixed resin layer comprising a vinyl chloride resin and a silicone acrylic copolymer, in which 2.5 to 10 pts.wt. of said silicone acrylic copolymer are mixed per 100 pts.wt. of said vinyl chloride resin.
